(19) United States
(12) Patent Application Publication
(10) Pub. No.: US 2013/0006568 A1
(43) Pub. Date: Jan. 3, 2013

(54) Test Operation

(75) Inventors: Michael Baylis, Southampton (GB); David M. Key, Winchester (GB); William L. Yates, Portsmouth (GB)

(73) Assignee: INTERNATIONAL BUSINESS MACHINES CORPORATION, Armonk, NY (US)

(21) Appl. No.: 13/634,289

(22) PCT Filed: Jun. 1, 2011
(86) PCT No.: PCT/EP11/59152

§ 371 Date: Sep. 12, 2012

(30) Foreign Application Priority Data
Jun. 3, 2010 (EP) 10164846

(51) Int. Cl. G06F 19/00

(52) U.S. Cl. 702/108

(57) ABSTRACT

A method of operating a test in a test environment comprises running the test, detecting the generation of events during the test and for each detected event, populating one or more result buckets according to one or more validation routines. Each validation routine defines a result to add to a result bucket according to a characteristic of the detected event. Once the test is completed, or during the running of the test, one or more test scenarios are run against the result buckets, with each test scenario returning an outcome according to one or more algorithms processing the results in the result buckets. In a preferred embodiment, the populating of the one or more result buckets is according to validation routines that populate a matrix of result buckets, each result bucket being populated during a specific time period.

### BACKGROUND

This invention relates to a method of, and system for, operating a test in a test environment. In one embodiment, the invention provides a method for better identifying confidence in a test scenario to distinguish the grey area between a pass and a fail.

Test plans, test cases and, in particular, automated tests are based upon a very distinct divide between pass and fail. These tests presume that given a specific set of circumstances and actions a specific result will always be returned. If it does the test is passed, but if not the test is failed. For simple functional tests this is often perfectly adequate. Even for large complicated environments, where the number of functions and the complexity of their interactions have increased the number of tests exponentially, it is still possible to validate individual results in this way. Indeed, methodologies such as model-based testing rely on the ability to map every individual path through code to validate that each has been exercised and behaves as expected. However, this approach can often result in a misplaced confidence that functional coverage can be equated to product quality, or usage.

In complex systems with multiple users concurrently exercising different product functionality, often using common resources, the functional model is often inadequate or, at best, rapidly reaches a point where it has an unsustainable level of complexity in order to manage the testing process. The behaviour of an individual task must be able to relate to both the basic functional test and to the context within which it occurs. More significantly, the behaviour of all of the individual tasks in consort must be viewed as a whole in order to understand whether the tasks, and the system(s) as a whole, are functioning as expected.

Similarly, whilst in functional testing the boundaries of the test are well defined, in system testing this is less true. Issues of scale, longevity, workload and fluctuations in work patterns all combine to create a grey area where individual elements of a test may succeed but, when combined, will fail to achieve the ultimate goal of the test scenario. An example of this would be where a scenario requires a workload to achieve a threshold level of throughput for at least “x” times, without failure, within a predetermined interval. In normal functional, and modelled, testing, the emphasis would be on the success or failure of the individual tasks within the workload. The ability to relate this to the fluctuations or reasonable changes or failures would either be a post-processing task or would require extremely complex modelling.

The complexity of modelled scenarios is largely because, for functional tests, the environment and scenario are created to enable the test case that is being checked to be validated as a pass or fail. It also forces testing to be compartmentalised, with individual components being tested in isolation, to contain the level of complexity and to avoid the risk of one scenario impacting another. This is a direct reversal of reality, where functions are used within an environment. Real environments and workloads are not predefined or static, they are fluid. Testing must be able to cope with this dynamic environment, but without overburdening the test environment with overly complex or cumbersome test metrics.

Since real environments and workloads are fluid, test scenarios must not dictate the environment, or the work within that environment. Instead they must be able to assess whether the work, and behaviour of that work, is consistent with the functional expectations (the traditional limit of testing) and consistent with the overall objectives of the scenario. This may be much more use or business case than functionally driven. It is important, from a testing point of view, to prove that the system under test is capable of fulfilling a role rather than performing an action.

It is therefore an object of the invention to improve upon the known art.

### BRIEF SUMMARY

According to a first aspect of the present invention, there is provided a method of operating a test in a test environment comprising running the test in the test environment, detecting the generation of events during the test, for each detected event, populating one or more result buckets according to one or more validation routines, the or each validation routine defining a result to add to a result bucket according to a characteristic of the detected event, and running one or more test scenarios against the result buckets, the or each test scenario returning an outcome according to one or more algorithms processing the results in the result buckets.

According to a second aspect of the present invention, there is provided a system for operating a test in a test environment comprising a processing function arranged to run the test in the test environment, detect the generation of events during the test, for each detected event, populate one or more result buckets according to one or more validation routines, the or each validation routine defining a result to add to a result bucket according to a characteristic of the detected event, and run one or more test scenarios against the result buckets, the or each test scenario returning an outcome according to one or more algorithms processing the results in the result buckets.

According to a third aspect of the present invention, there is provided a computer program product on a computer readable medium for operating a test in a test environment, the product comprising instructions for running the test in the test environment, detecting the generation of events during the test, for each detected event, populating one or more result buckets according to one or more validation routines, the or each validation routine defining a result to add to a result bucket according to a characteristic of the detected event, and running one or more test scenarios against the result buckets, the or each test scenario returning an outcome according to one or more algorithms processing the results in the result buckets.

Owing to the invention, it is possible to provide a testing solution that combines the individual functional tests with a dynamic view of the context. The solution provides the ability to allow test scenarios to exist and to validate success, within a changing environment. The testing method supports the definition of use and business requirements as eligibility criteria to be assessed and tested within that environment.

A system test environment uses the result buckets and scenario eligibility criteria to allow test scenarios to exist independently of both the actual environment under test and the functional validation to that environment provided by event based processing. This allows the test scenarios to be validated against the requirement(s) of the use case that is being evaluated, rather than the individual functional components that make up the system being tested. As the events generated by the work running in the test environment are validated, rather than simply reporting a pass or fail the validated events are used to populate one, or more, result buckets with the results from the validation. The result buckets can be anything from a simple count to a more complex value, from example a response time, and this means that a single validation routine can populate multiple result buckets at the same time, thereby enabling a far more simple and flexible way to manage the results of a single task (or combination of tasks) for multiple test requirements.

For example, within the testing environment, a single task routed from one system to another might result in changes to firstly, a pair of buckets each containing a simple count of successes and failures respectively, secondly a set of buckets based on the same count of successes and fails but further qualified by the type of connection used and thirdly a pair of buckets each containing the response times of tasks. This allows different results to be captured without any change to the actual test and regardless of the environment or workload being run. These result buckets can then be used to decide whether the eligibility criteria for a scenario have been met. The concept of eligibility criteria allows the tester to define the criteria by which the work running within an environment will be considered to be valid for inclusion in the assessment and complete.

Since the criteria defines which factors must be met for a scenario to considered active, the scenario can be used within any environment and workload but only be assessed once the validity criteria are met. Similarly, the scenario can be left active until the configuration, workload and results combine to fulfil these requirements. The separation of eligibility criteria and result buckets from the actual test processing or validation allows a test scenario to focus on the user or business requirements, without being concerned with the actual operation of the workload. This allows for a massive simplification of the scenario, the ability to reuse it within different environments and with other scenarios being evaluated at the same time.

Preferably, the method further comprises receiving an event list defining the events to be detected during the test. Each test transaction issues a standard set of events that are specific points within the test transaction. Each standard event will contain the event ID, correlation ID and timestamp, along with a mandatory payload. An event list is used to keep track of the set of events that will be detected during the running of the test. This list can be extended or contracted according to the results being sought by the tester with respect to the system under test.

Advantageously, the method step of populating one or more result buckets according to one or more validation routines comprises populating a matrix of result buckets, each result bucket being populated during a specific time period. In this case, the method step of running one or more test scenarios against the result buckets comprises selecting one or more results buckets from one or more specific time periods. By providing result buckets that are limited by time periods, a very precise view of the operation of the test system throughout the entire test can be achieved.

Ideally, the method further comprises populating one or more result buckets according to one or more validation routines, the or each validation routine defining a result to add to a result bucket according to a characteristic of more than one detected event. On the validation side an event router can be used to reads the event from an event log. The router will look at a configuration record to determine which validation routines are active and in which events those routines are interested. The router will pass the appropriate events to the appropriate validation routines. Each validation routine will run and analyse the event and record the results. A validation routine may require more than one event to determine a result. The validation routine can place itself into the background until it is called by the event router with the second event that correlates with the first event.

### BRIEF DESCRIPTION OF THE SEVERAL VIEWS OF THE DRAWINGS

Embodiments of the present invention will now be described, by way of example only, with reference to the accompanying drawings, in which:

FIGS. 1, 2 and 3 are schematic diagrams of a software testing environment, and

FIG. 4 is a schematic diagram of a Customer Information Control System (CICS) environment.

### DETAILED DESCRIPTION

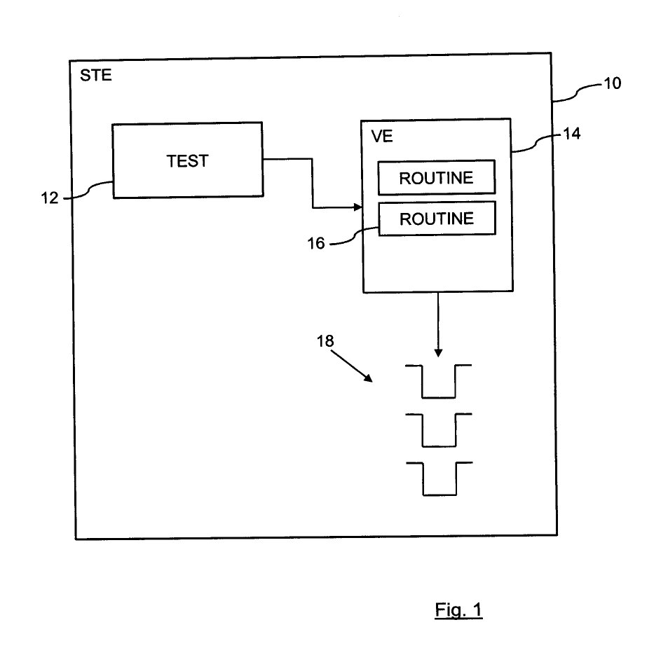

FIG. 1 shows an example of a system test environment 10. In the system test environment 10 a processing function runs one or more tests 12 on systems that need to be tested. When the tests 12 are run, they generate events which are then passed to a validation environment 14 for evaluation by validation routines 16. An event might be a link to an object or a communication between two specific components within the system being tested. The validation routines 16 are designed to listen for the events that are relevant to the respective routines 16. As the validation routines 16 process the events that they receive, they populate result buckets 18.

The population of the buckets 18 can be based on a standard format for the content and a naming convention that allows the purpose of the bucket 18, for example a count of how many transactions are routed over different connection types, to be identified by any test scenario that wishes to use the information in the individual bucket 18. As the test 12 (or tests 12) is/are run, the buckets 18 will be filled according to the validation routines 16 that are populating the buckets 18. A single validation routine 16 may populate more than one bucket 18 and a single bucket 18 may be populated by more than one validation routine 16.

Once a bucket 18 has been written to by a validation routine 16, the validation routine 16 then ceases to have any involvement with the bucket 18, which becomes a discrete entity available for analysis by any, or all, test scenarios. This means that a single result bucket 18 can be used for many different tests 12, and can be combined, as required, with other result buckets 18 that may have been updated by the same or different validation routines 16, to form a more complete picture of the inter-relationships between otherwise discrete work. Once the test 12 has completed, the information within the buckets 18 is available and can be stored for future use.

The validation environment 14 is arranged to detect the generation of events during the test 12 and for each detected event, populates one or more result buckets 18 according to the validation routines 16. Each validation routine 16 defines a result to add to a result bucket 18 according to a characteristic of the detected event. The simplest result that can be added to a result bucket 18 is a count which simply monitors the number of times that a specific event occurs. More complex results can be recorded in the results buckets 18, such as the time taken for a specific event to occur or details about a data channel used during a particular event.

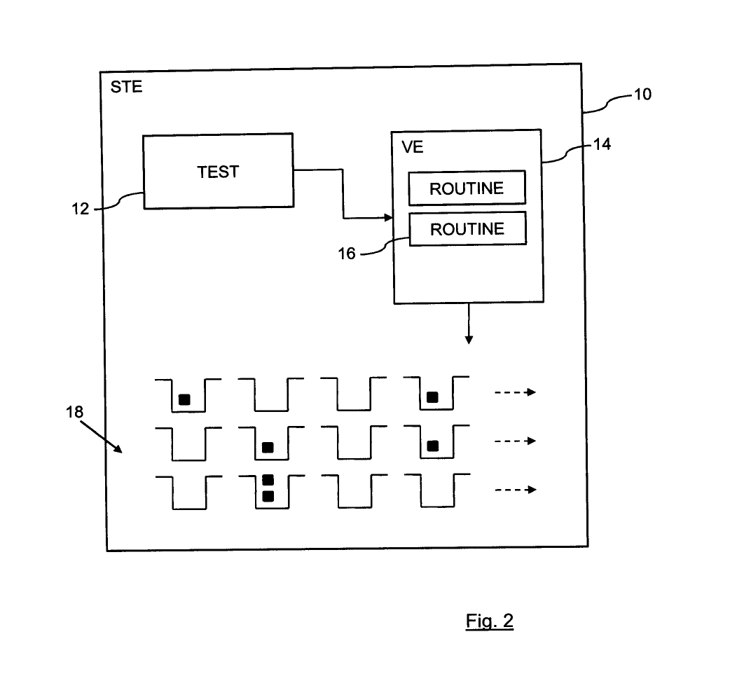

In a preferred embodiment, the populating of the results buckets 18, according to the validation routines 16, comprises populating a matrix of result buckets 18, each result bucket 18 being populated during a specific time period. This is illustrated in FIG. 2. Each result bucket 18 is limited to a specific time period and the events that trigger the placing of results in specific results buckets 18 are timed so that the correct buckets 18 are used, when the validation routines 16 are placing results in the relevant buckets 18. The matrix of buckets 18 therefore provides a view of the test 12 that is split into discrete time periods.

The testing system embodied in the Figures provides a separation between the actual test 12 and the result buckets 18. The event detection and the validation routines 16 populate the result buckets independently of the actual test operation and specific test scenarios are then used on the results buckets 18 once the test 12 has completed. The test scenarios will return results that can be used by a tester with respect to the system under test, but without interfering or affecting the performance of the system being tested or the operation of the test 12. The results buckets 18 provide data that can be used by one or more test scenarios.

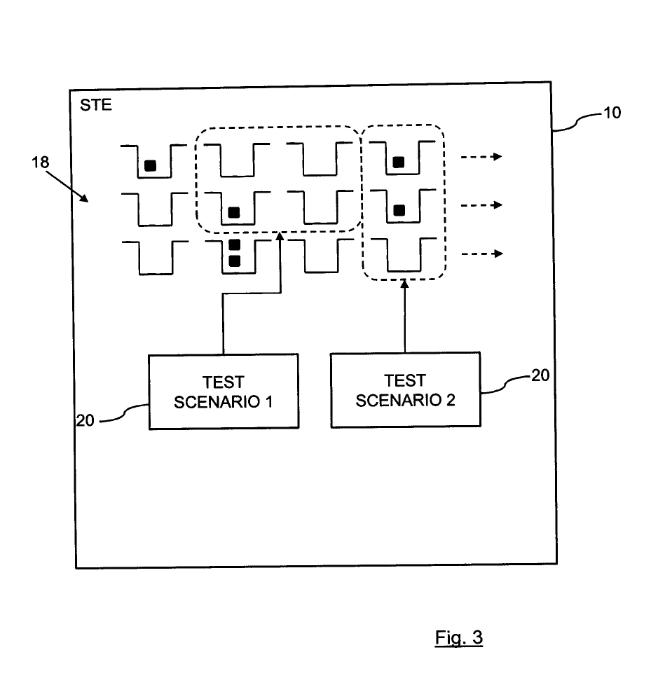

FIG. 3 shows a pair of test scenarios 20 that can be used to process the results contained within the result buckets 18. After completion of the tests 12, or during the test run, one or more test scenarios 20 are run against the result buckets 18, with each test scenario 20 returning an outcome according to one or more algorithms processing the results in the result buckets 20. The test scenarios 20 run independently of the original tests 12 that actually were performed on the system under test. The scenarios 20 can work on single buckets 18 or can work on combinations of buckets 18, using different buckets 18 or the same bucket 18 spread over different time periods.

The test scenarios 20 can be predesigned for specific system implementations and/or can be taken from an existing suite of test scenarios 20. Further test scenarios 20 can be selected or designed from scratch depending upon the results provided by the first set of scenarios 20 that are run. The tester can review the results from different test scenarios 20 to see if any further examination of the test data is needed using additional test scenarios 20. The advantage of this system is that the original tests 12 do not need to be rerun, as the data that has been produced by the tests 12 is still available within the results buckets 18.

The test scenarios 20 can break down their analysis into chunks, based on periods of time suitable to that scenario 20. This allows, for example, two scenarios 20 to use different levels of granularity when analysing the same information. Once the analysis intervals are established, the scenario 20 identifies the result buckets 18 that are to be analysed. Using eligibility criteria for both individual periods and for a scenario 20 as a whole, it is possible to allow fluctuations and changes in both the workload and the environment to occur, for the scenario 20 to hibernate until required but still register when the amount of work required to achieve the level of confidence needed to achieve the user requirement identified by the scenario 20.

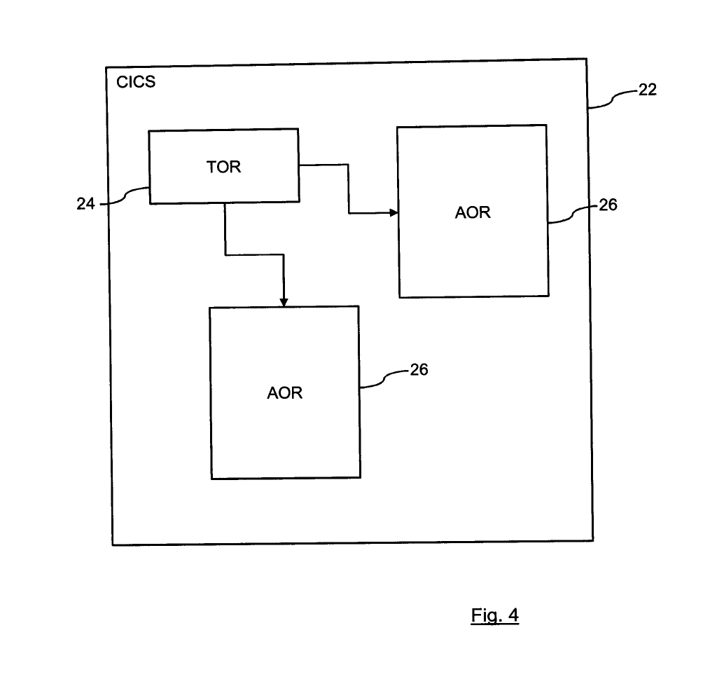

An example of a system that could be tested using the testing environment of FIGS. 1 to 3 is shown in FIG. 4. Here, a Customer Information Control System (CICS) environment 22 routes tasks from a terminal owning region 24 to two different application owning regions 26. A first application owned region 26 is connected to the terminal owning region 24 via a Multi Region Operation (MRO) Connection, the second application owned region 26 is connected using an IP intercommunications (IPIC) Connection. The workload that forms the test 12 uses a mixture of Distributed Program Links (DPL) and routed Non-Terminal Starts (NTS) in the work that is carried out. In this example, a validation routine 16 creates result buckets 18 that are based on a combination of commands target_system, connection_type and how_initiated. For example, a bucket 18 with the name AOR1.MRO.NTS would contain a count of the number of tasks initiated using a Non-Terminal Start in the first application owned region (AOR1) across an MRO connection. This bucket 18 will be populated by a validation routine 16 that is specifically monitoring for events that fulfil this criteria.

A business use case that is identified by a specific test scenario 20 could be to prove that a minimum level of throughput can be maintained for a set period of time within the implementation of the CICS environment 22. The first stage of this process would be to prove that this level of throughput has been achieved, in an individual period, for programs initiated using a Distributed Program Link (DPL). To do this the following period eligibility can be defined as:

(MAX(BUCKETS(*.DPL,COUNT))/PERIODLENGTH( ))>50

Here the count of records in any result bucket 18 ending in “.DPL” is totalled and then divided by the length of the defined time period. If the number exceeds the stated minimum of 50 then that particular period would be eligible for inclusion in the wider test scenario validation. If the result returned was less than 50 it would not fail, it would simply be considered ineligible for inclusion in the overall scenario eligibility.

The period eligibility allows for fluctuations in the work to be accommodated, without necessarily failing the test as a whole. Failure in a period is treated as an entirely separate test. For example in the same scenario the period failure could be defined as:

MAX(BUCKETS(*.FAILED,COUNT),BUCKETS(*.TIMEOUT,COUNT))>0

Here, only if the validation has updated a failure or timeout result bucket 18 with a record during the evaluated period will the evaluated period be considered to have failed. If other result buckets 18 were populated, for example a Non-Terminal START was used rather than a DPL, these would simply be ignored, as they are of no interest to this particular test scenario 20, though they may be used by a different scenario 20 (or scenarios) running at the same time and using the same environment, workload and validation routines.

Having the ability to specify the period eligibility and failure conditions as equations with wildcard values, in the test scenario queries, enables the same result buckets 18 to be used for multiple, and potentially entirely different, scenarios 20 at the same time, with no additional test effort or overhead. Individual periods can then be combined to assess whether the criteria for the scenario 20 itself has been achieved. For example, if the throughput described above had to be sustained for one hour, and the period length was a five minute interval, then the scenario eligibility would require at least twelve consecutive periods where the period eligibility was achieved in order to provide a positive result.

Similarly, scenario failure can be based on an assessment of the period failure(s) that is/are recorded. This gives a positive indicator of when a test has failed. In contrast, scenario eligibility is achieved when enough successful tests have been run for the use case being validated by the scenario 20 to be considered successful. This provides a flexible method for interpreting the results provided by the result buckets 18. Individual scenarios 20 can make period dependent enquires of the results buckets 18 and these can be used to provide an overall success or fail result for a specific scenario 20.

The testing methodology uses event based validation. The standard way of writing a test transaction would be to write application code that exercises some functionality which is surrounded with test metrics. Event based validation, however, extracts the test metrics from the test transaction and runs it elsewhere. This allows the test transaction to exercise the functionality and not much else, and therefore runs similarly to a user transaction. Instead of running test metrics, the test transaction performs a data capture. This captures relevant data such as where the transaction ran, what userid it ran under, what the return code of the function was etc. This data is then written to a high-speed log as an event along with an event ID, correlation ID and timestamp, to uniquely identify the event.

Using predefined standards, certain points within the application code will issue specific events, each with its mandatory data payload. The data capture and event writing is very lightweight compared to the heavyweight test metrics it is replacing. As the test transaction only captures data about the environment, the test transaction is now able to run in any configuration, workload or scaled systems without any changes to the code. Similarly, by using common sub-routines to generate event payloads, updates can be performed centrally without large rewrites of application code, reducing the resource overhead and the chance of code errors.

The extracted test metrics are available to standalone programs operating as validation routines, which can be run on a separate machine. The validation routines will read the events off the high-speed log and analyse the captured data for success or failure conditions. As there is now separation between the test transaction and validation routine, the validation routine can become very complex without affecting the throughput of the test environment.

A validation routine will register with the events in which it is interested and is called whenever that event appears on the high-speed log. This gives the ability to write multiple validation routines that utilises the data on a single event, so that a suite of validation routines can be written, each concentrating on a single functionality. Implementing a combination of those validation routines into a test environment means it is possible to analyse the results of multiple functionality tests from a single event.

New events can be added without breaking existing validation routines. As new testing requirements arise, new validation routines can be added to process existing events without having to change the test transactions. The existence of the results buckets means that it is possible to replay a test but with added new validation routines to obtain added value from an existing test run. It is possible dynamically to add and remove validation routines whilst the test is in progress if a tester identifies or suspects that something unusual is occurring. The testing solution is not restricted to a single platform. It can be adapted to any platform where a high-speed log or message queue can be written to or read from asynchronously. The solution can use multiple platforms in a single test as long as all the platforms have a method of writing to the event log. The validation routines do not have to run in real time, so the test process can be run as a post-process or run on a slow older machine.

Each test transaction issues a standard set of events that are specific points within the test transaction. Each standard event will contain the event ID, correlation ID and timestamp, along with a mandatory payload. The test transaction may add an optional payload if it provides added value for that specific transaction. These events are written to a high-speed log (or journal) that is capable of supporting parallel writes and reads, i.e. multiple servers writing to the same log.

On the validation side an event router reads the events from the log. The router will look at a configuration record to determine which validation routines are active and in which events those routines are interested. It will pass the appropriate events to the appropriate validation routines using multi-threading. Each validation routine will run and analyse the event and record the results. If the validation routine requires more than one event to determine the result, it can use the correlation ID contained within the event to find partnered events. The validation routine can place itself into the background until it is called by the event router with the second event with the same correlation ID as the first event.

1. A method, in a data processing system, of operating a test a test environment, the method comprising:
running, by a processor, the test in the test environment,
detecting, by the processor, generation of events during the test thereby forming detected events,
for each detected event, populating, by the processor, one or more result buckets according to one or more validation routines, wherein the one or more validation routines define a result to add to a result bucket in the one or more result buckets according to a characteristic of the detected event, and
running, by the processor, one or more test scenarios against the one or more result buckets, wherein the one or more test scenarios return an outcome according to one or more algorithms executed by the processor in processing the results in the result buckets.

2. The method according to claim 1, further comprising:
receiving, by the processor, an event list defining the events to be detected during the test.

3. The method according to claim 1, wherein the step of populating the one or more result buckets according to one or more validation routines further comprises:
populating, by the processor, a matrix of result buckets, wherein each result bucket in the matrix of result buckets is populated during a specific time period.

4. The method according to claim 3, wherein the step of running one or more test scenarios against the one or more result buckets further comprises:
selecting, by the processor, one or more results buckets from one or more specific time periods.

5. The method according to claim 1, further comprising:
populating, by the processor, one or more result buckets according to one or more validation routines, wherein each validation routine in the one or more validation routines define a result to add to a result bucket according to a characteristic of more than one detected event.

6. A system for operating a test in a test environment comprising:
a processor; and
a memory coupled to the processor, wherein the memory comprises instructions which, when executed by the processor, cause the processor to
run the test in the test environment,
detect generation of events during the test thereby forming detected events,
for each detected event, populate one or more result buckets according to one or more validation routines, wherein the one or more validation routines define a result to add to a result bucket in the one or more result buckets according to a characteristic of the detected event, and
run one or more test scenarios against the one or more result buckets, wherein the one or more test scenarios return an outcome according to one or more algorithms executed by the processor in processing the results in the result buckets.

7. The system according to claim 6, wherein the instructions further cause the processor to:
receive an event list defining the events to be detected during the test.

8. The system according to claim 6, wherein the instructions, when populating one or more result buckets according to one or more validation routines, further cause the processor to:
populate a matrix of result buckets, wherein each result bucket in the matrix of result buckets is populated during a specific time period.

9. The system according to claim 8, wherein the instructions, when running one or more test scenarios against the result buckets, further cause the processor to:
select one or more results buckets from one or more specific time periods.

10. A system according to claim 6, wherein the instructions further cause the processor to:
populate one or more result buckets according to one or more validation routines, wherein each validation routine in the one or more validation routines define a result to add to a result bucket according to a characteristic of more than one detected event.

11. A computer program product comprising a computer readable storage medium having a computes readable program for operating a test in a test environment stored thereon, wherein the computer readable program, when executed on a computing device, cases the computing device to:
run the test in the test environment,
detect generation of events during the test thereby forming detected events,
for each detected event, populate one or more result buckets according to one or more validation routines, wherein the one or more validation routines define a result to add to a result bucket in the one or more result buckets according to a characteristic of the detected event, and
run one or more test scenarios against the one or more result buckets, wherein the one or more test scenarios return an outcome according to one or more algorithms executed by processor in processing the results in the result buckets.

12. The computer program product according to claim 11, wherein the computer readable program further causes the computing device to:
receive an event list defining the events to be detected during the test.

13. The computer program product according to claim 11, wherein the computer readable program for populating one or more result buckets according to one or more validation routines further causes the computing device to:
populate a matrix of result buckets, wherein each result bucket in the matrix of result buckets is populated during a specific time period.

14. The computer program product according to claim 13, wherein the computer readable program for running one or more test scenarios against the result buckets further causes the computing device to:
select one or more results buckets from one or more specific time periods.

15. The computer program product according to claim 11, wherein the computer readable program further causes the computing device to
populate one or more result buckets according to one or more validation routines, wherein each validation routine in the one or more validation routines define a result to add to a result bucket according to a characteristic of more than one detected event.
